(19) United States
(12) Patent Application Publication
(10) Pub. No.: US 2025/0210220 A1
(43) Pub. Date: Jun. 26, 2025

(54) WIRE HARNESS ASSEMBLY

(71) Applicant: Yazaki Corporation, Tokyo (JP)

(72) Inventor: Yukio NISHIO, Shizuoka (JP)

(73) Assignee: Yazaki Corporation, Tokyo (JP)

(21) Appl. No.: 18/975,240

(22) Filed: Dec. 10, 2024

(30) Foreign Application Priority Data
Dec. 20, 2023 (JP) 2023-214995

(51) Int. Cl. H01B 7/00; B60R 16/02

(52) U.S. Cl. CPC H01B 7/0045; B60R 16/0207

(57) ABSTRACT

A wire harness assembly includes: a wire harness including an electric wire and a connector electrically connected to an end of the electric wire; and an assembly member in which the wire harness is arranged. The assembly member includes: a body in which the electric wire is arranged; and an extension in which the connector is arranged, the extension being formed as a single member continuous with the body.

### CROSS-REFERENCE TO RELATED APPLICATIONS

The present application is based on and claims the benefit of priority from the prior Japanese Patent Application No. 2023-214995, filed on Dec. 20, 2023, the entire contents of which are incorporated by reference herein.

### TECHNICAL FIELD

The disclosure relates to a wire harness assembly.

### BACKGROUND

JP 2015-67071 A describes a wire harness assembly including a wire harness and an assembly sheet as an assembly member in which the wire harness is arranged, the wire harness including an electric wire and a connector electrically connected to an end of the electric wire. In the wire harness assembly, only the electric wire is arranged inside the assembly sheet, and the end of the electric wire, where the connector is located, is exposed from the assembly sheet. The wire harness assembly becomes compact, when packaged or the like, by folding back the end of the electric wire exposed from the assembly sheet to the assembly sheet.

### SUMMARY

In the wire harness assembly described above, the connector provided at the end of the electric wire is exposed from the assembly member. Therefore, there is a possibility that the connector interferes with peripheral members and the connector and the peripheral members are damaged when the wire harness assembly is packaged or assembled to a target member.

The disclosure is directed to a wire harness assembly capable of preventing a connector from interfering with peripheral members.

A wire harness assembly in accordance with some embodiments includes: a wire harness including an electric wire and a connector electrically connected to an end of the electric wire; and an assembly member in which the wire harness is arranged. The assembly member includes: a body in which the electric wire is arranged; and an extension in which the connector is arranged, the extension being formed as a single member continuous with the body.

According to the above-described configuration, in the wire harness assembly, the connector can be prevented from interfering with peripheral members.

### BRIEF DESCRIPTION OF THE DRAWINGS

FIG. 1 is a perspective view of a wire harness assembly according to an embodiment.

FIG. 2 is an exploded perspective view of the wire harness assembly according to the present embodiment.

FIG. 3 is an enlarged perspective view of a main part of the wire harness assembly according to the present embodiment.

FIG. 4 is an enlarged perspective view of a main part when a cover extension is peeled off from a base extension of the wire harness assembly according to the present embodiment.

### DETAILED DESCRIPTION

Hereinafter, a wire harness assembly 1 according to an embodiment will be described in detail with reference to the drawings. Note that dimensional ratios in the drawings are exaggerated for convenience of explanation, and may be different from actual ratios.

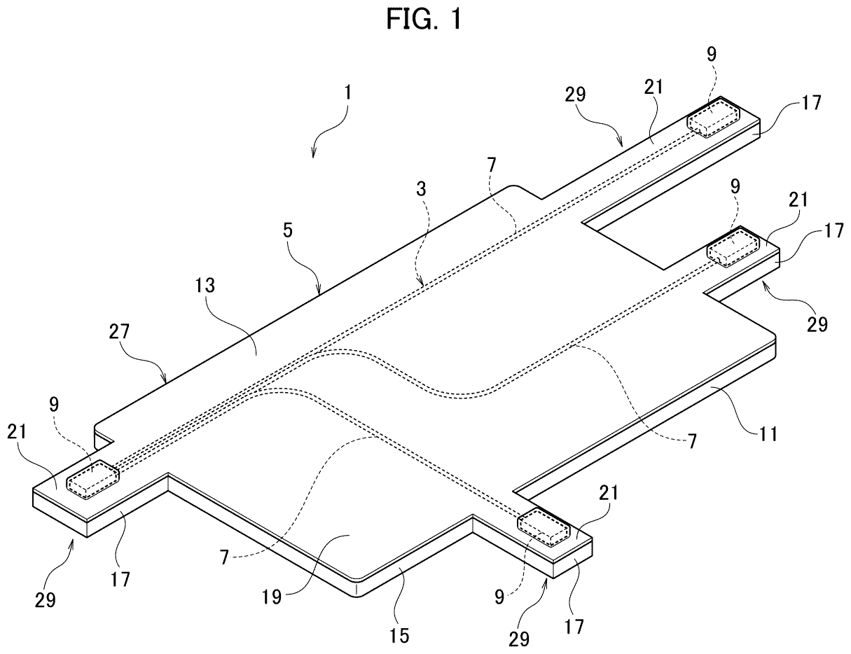

As illustrated in FIG. 1, the wire harness assembly 1 according to the present embodiment is applied to, for example, a wire harness 3 that electrically connects electrical components (not illustrated), e.g., a power supply mounted on a vehicle and a device or a device and a device. The wire harness 3 is arranged in a predetermined shape inside an assembly member 5 integrally assembled therewith. The wire harness assembly 1 is assembled to a target member (not illustrated), e.g., a door trim of a vehicle.

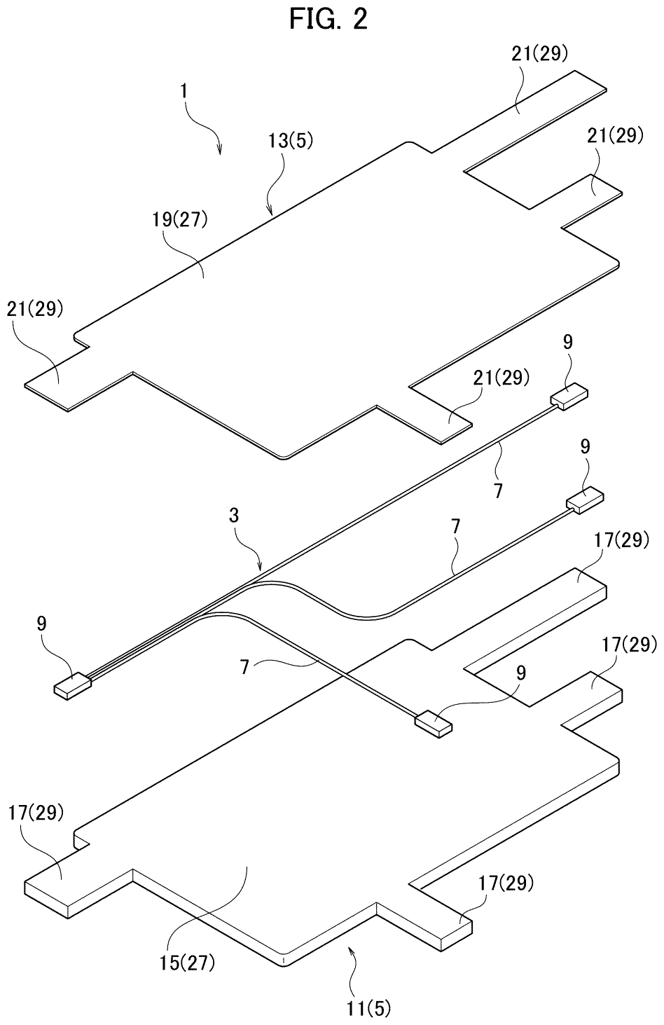

As illustrated in FIGS. 1 to 4, the wire harness assembly 1 includes a wire harness 3 and an assembly member 5.

As illustrated in FIGS. 1 to 4, the wire harness 3 includes an electric wire 7 and a connector 9.

The electric wire 7 includes, for example, a sheathed electric wire in which an outer periphery of a core wire made of a conductive material is sheathed with an insulating sheath, and a plurality of (three in the present embodiment) electric wires 7 are used. The electric wire 7 may be a flat cable in which outer peripheries of a plurality of core wires are sheathed with an insulating sheath in a state where the plurality of core wires are arranged in parallel. The plurality of electric wires 7 are arranged, with respect to the assembly member 5, in such a manner that one end sides thereof are collected at one location and the other end sides thereof are branched.

The connector 9 includes, for example, a housing (not illustrated) made of an insulating material such as a synthetic resin, and a terminal (not illustrated) made of a conductive material. The housing can be fitted to, for example, a mating housing (not illustrated) of a mating connector (not illustrated) electrically connected to an electric component mounted on the vehicle. The terminal is electrically connected to the end of the electric wire 7, and is accommodated in the housing. The terminal is electrically connected to a mating terminal (not illustrated) accommodated in the mating housing by fitting the housing to the mating housing. A plurality of (four in the present embodiment) connectors 9 are used to correspond to the ends of the plurality of electric wires 7.

As illustrated in FIGS. 1 to 4, the assembly member 5 includes a base 11 and a cover 13.

The base 11 is made of, for example, a foam of urethane or the like, or a nonwoven fabric of polypropylene fibers, polyethylene terephthalate fibers, polyester-based fibers, or the like, and has soundproofing and heat insulating properties. The base 11 is formed in a sheet shape with a size set so that the base 11 is arranged within the range of the target member, and is assembled to the target member by a fixing means (not illustrated) such as press fitting. The base 11 includes a base body 15 and a base extension 17. The base body 15 is formed in, for example, a rectangular shape. On one surface side of the base body 15, the plurality of (three in the present embodiment) electric wires 7 of the wire harness 3 are arranged in a predetermined shape. The base extension 17 is arranged with respect to the base body 15 to correspond to each of the plurality of (four in the present embodiment) connectors 9 of the wire harness 3. The base extension 17 extends outward from an outer edge of the base body 15 as a single member continuous with the base body 15. The end of the electric wire 7 and the connector 9 are arranged on one surface side of the base extension 17.

The cover 13 is made of, for example, a film of vinyl chloride, polyethylene, or the like, or a closed-cell foam or an open-cell foam of polyethylene, polypropylene, polystyrene, elastomer, or the like, and has soundproofing and heat insulating properties. The cover 13 is formed in a sheet shape with a size set to be equal to that of the base 11 so that the cover 13 is arranged within the range of the target member, and a thickness set to be smaller than that of the base 11, and includes a cover body 19 and a cover extension 21. The cover body 19 is formed in the same shape (a rectangular shape in the present embodiment) as the base body 15. An adhesive is applied onto a surface of the cover body 19 facing the base body 15, and the cover body 19 is attached to one surface side of the base body 15 in such a manner that the plurality of electric wires 7 are sandwiched between the cover body 19 and the base body 15. The base body 15 and the cover base 19 constitute a body 27 in which the electric wire 7 of the wire harness 3 is arranged in the assembly member 5. In a state where the cover body 19 is attached to the base body 15, the plurality of electric wires 7 arranged in a predetermined shape are held between the base 11 and the cover 13. Therefore, the body 27 of the assembly member 5 can protect the electric wire 7 of the wire harness 3, and maintain the arrangement shape of the electric wire 7.

The cover extension 21 is arranged with respect to the cover body 19 to correspond to each of the plurality of (four in the present embodiment) base extensions 17. The cover extension 21 extends outward from an outer edge of the cover body 19 in the same shape as the base extension 17 as a single member continuous with the cover body 19. An adhesive is applied onto a surface of the cover extension 21 facing the base extension 17, and the cover extension 21 is attached to one surface side of the base extension 17 in such a manner that the end of the electric wire 7 and the connector 9 are sandwiched between the cover extension 21 and the base extension 17. The base extension 17 and the cover extension 21 constitute an extension 29 in which the end of the electric wire 7 and the connector 9 of the wire harness 3 are arranged in the assembly member 5. In the assembly member 5, a plurality of (four in the present embodiment) extensions 29 are provided to correspond to all (four in the present embodiment) of the connectors 9. In a state where the cover extension 21 is attached to the base extension 17, the end of the electric wire 7 and the connector 9 are held between the base 11 and the cover 13. Therefore, the end of the electric wire 7 and the connector 9 of the wire harness 3 can be protected by the extension 29 of the assembly member 5. By protecting the connector 9 with the extension 29, it is possible to prevent direct interference between the connector 9 and peripheral members when the wire harness assembly 1 is packaged or assembled to the target member. Therefore, it is possible to suppress damage to the connector 9 and the peripheral members. In addition, since the extensions 29 are provided to correspond to all the connectors 9, all the connectors 9 of the wire harness 3 can be protected.

For example, when the wire harness assembly 1 is packaged, if the extension 29 protrudes from a packaging box, the extension 29 may be folded back toward the body 27. Even in such a state, the connector 9 is not exposed to the outside, and direct interference between the connector 9 and peripheral members can be prevented.

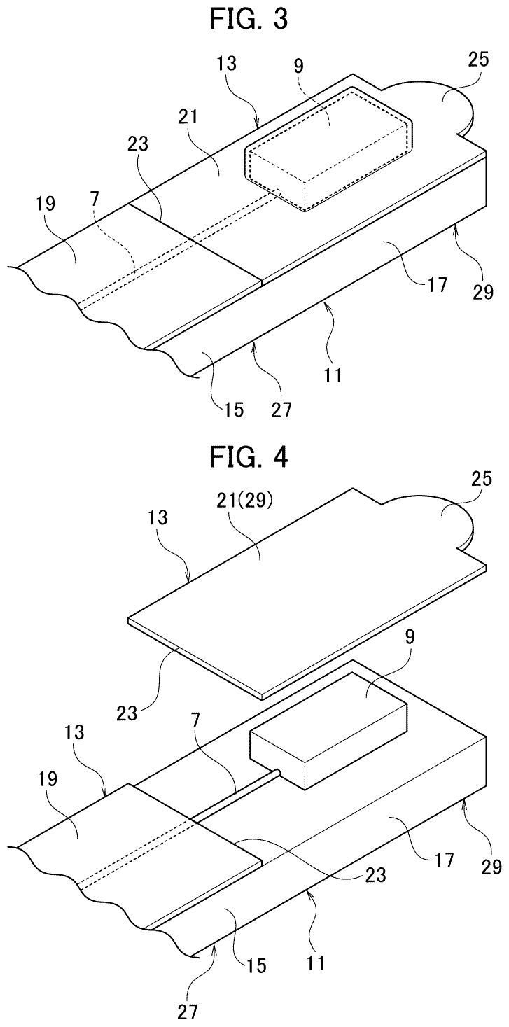

As illustrated in FIGS. 3 and 4, the cover 13 includes a dividing portion 23. The dividing portion 23 is formed, for example, by making cuts (notches) in the cover 13. The dividing portion 23 is arranged at a position where the end of the electric wire 7 is exposed with a predetermined length when the cover extension 21 is peeled off from the base extension 17. When the cover extension 21 is peeled off from the base extension 17, the dividing portion 23 divides the cover body 19 and the cover extension 21, making it possible to peel off only the cover extension 21 from the base extension 17. For example, when the wire harness assembly 1 is assembled to the target member, the connector 9 can be exposed by peeling off the cover extension 21 divided by the dividing portion 23 from the base extension 17. Therefore, when the connector 9 is exposed, it is not necessary to press or cut the cover 13 at a predetermined position with a jig or the like, and assemblability can be improved. In addition, by arranging the dividing portion 23 at a position where the end of the electric wire 7 is exposed with a predetermined length, the connector 9 can be easily fitted to a mating connector, and assemblability can be improved. In the present embodiment, the dividing portion 23 is arranged to divide the cover extension 21 from the cover body 19, but the present invention is not limited thereto. For example, in a case where the length of the extension 29 extending from the body 27 is long, the dividing portion 23 may be arranged at a position where only the cover extension 21 covering the end of the electric wire 7 and the connector 9 is divided when the cover extension 21 is peeled off from the base extension 17.

As illustrated in FIGS. 3 and 4, the cover 13 includes a grip 25. The grip 25 protrudes outward from an outer edge of the cover extension 21 as a single member continuous with the cover extension 21. The grip 25 is arranged to protrude from an outer edge of the base extension 17 in a state where the cover extension 21 is attached to the base extension 17. The grip 25 is not coated with an adhesive. The grip 25 is a portion gripped by, for example, a worker when the cover extension 21 is peeled off from the base extension 17. By providing the grip 25 in the cover extension 21, the cover extension 21 can be easily peeled off from the base extension 17, and assemblability can be improved.

The wire harness assembly 1 according to the present embodiment includes a wire harness 3 including an electric wire 7 and a connector 9 electrically connected to an end of the electric wire 7, and an assembly member 5 in which the wire harness 3 is arranged. The assembly member 5 includes a body 27 in which the electric wire 7 is arranged, and an extension 29 in which the connector 9 is arranged, the extension 29 being formed as a single member continuous with the body 27.

Since the connector 9 is arranged inside the extension 29 of the assembly member 5, the connector 9 can be protected. Therefore, it is possible to prevent direct interference between the connector 9 and peripheral members when the wire harness assembly 1 is packaged or assembled to the target member, and it is possible to suppress damage to the connector 9 and the peripheral members.

Therefore, in the wire harness assembly 1, the connector 9 can be prevented from interfering with the peripheral members.

A plurality of connectors 9 are provided. The extension 29 is provided to correspond to each of the connectors 9.

Therefore, all the connectors 9 of the wire harness 3 can be protected.

The assembly member 5 includes a base 11 and a cover 13 attached to the base 11.

Therefore, in the extension 29 of the assembly member 5, the connector 9 can be easily exposed by peeling off the cover 13 from the base 11, and assemblability can be improved.

The cover 13 includes a dividing portion 23 capable of dividing the cover 13 to expose the connector 9 when the cover 13 is peeled off from the base 11. Therefore, when the connector 9 is exposed, it is not necessary to press or cut the cover 13 at a predetermined position with a jig or the like, and assemblability can be improved.

The cover 13 includes a grip 25 protruding from an outer edge of the base 11.

Therefore, by gripping the grip 25 when the cover 13 is peeled off from the base 11, the cover 13 can be easily peeled off from the base 11, and assemblability can be improved.

In the above-described embodiment, the number of the electric wires 7 in the wire harness 3 is three, but the present invention is not limited thereto, and the number of the electric wires 7 may be two or less or may be four or more. In the above-described embodiments, one end sides of the plurality of electric wires 7 are collected into one connector 9, but the present invention is not limited thereto, and the connector 9 may be provided on each of one end sides of the plurality of electric wires 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wire harness assembly comprising:
a wire harness including an electric wire and a connector electrically connected to an end of the electric wire; and
an assembly member in which the wire harness is arranged, wherein the assembly member includes:
a body in which the electric wire is arranged; and
an extension in which the connector is arranged, the extension being formed as a single member continuous with the body.

2. The wire harness assembly according to claim 1, wherein
the connector comprises a plurality of connectors, and
the extension is provided to correspond to each of the plurality of connectors.

3. The wire harness assembly according to claim 1, wherein the assembly member includes:
a base; and
a cover attached to the base.

4. The wire harness assembly according to claim 3, wherein the cover includes a dividing portion configured to divide the cover to expose the connector when the cover is peeled off from the base.

5. The wire harness assembly according to claim 3, wherein the cover includes a grip protruding from an outer edge of the base.
